(19) United States
(12) Patent Application Publication
(10) Pub. No.: US 2026/0236361 A1
(43) Pub. Date: Aug. 13, 2026

(54) Image Processing Device and Image Processing Method

(71) Applicant: Sony Interactive Entertainment Inc., Tokyo (JP)

(72) Inventor: Akito Ota, Tokyo (JP)

(73) Assignee: Sony Interactive Entertainment Inc., Tokyo (JP)

(21) Appl. No.: 19/640,749

(22) Filed: Apr. 7, 2026

Related U.S. Application Data
(63) Continuation of application No. PCT/JP2024/035687, filed on Oct. 4, 2024.

(30) Foreign Application Priority Data
Oct. 11, 2023 (JP) 2023-176213

(51) Int. Cl. G06F 11/263

(52) U.S. Cl. CPC G06F 11/263

(57) ABSTRACT

A test assistance device includes a memory that stores a program and a processor that executes the program. The processor, by executing the program, selects, based on a first attribute included in a test case group of system software, a target test case that is a test execution target from the test case group, determines, based on a second attribute included in the selected target test case, whether the target test case is a test case for automatic test, and classifies the target test cases into the target test case for automatic test and the target test case for manual test.

### CROSS-REFERENCES TO RELATED APPLICATIONS

This application is a continuation of International Patent Application No. PCT/JP2024/035687, filed on October 4, 2024, which claims priority to Japanese Patent Application No. 2023-176213, filed on October 11, 2023, the entire disclosures of which is incorporated herein by reference for all purposes.

### TECHNICAL FIELD

The present disclosure relates to a test assistance device, a test assistance method, a test assistance program, and a recording medium.

### BACKGROUND

Test assistance devices that output a test case have been known. For example, JP 2022-14468 A describes a test assistance device that includes a memory and a processor. The memory is loaded with a test requirement acquisition section, a test requirement analysis section, a test case analysis section, and a test case output section as programs. The processor functions as each functional section by executing processing according to the programs loaded in the memory.

The test requirement analysis section performs natural language analysis of a new test requirement described in natural language, and outputs a result of the natural language analysis as test requirement quantified data. The test case analysis section compares the input quantified data of the new test requirement and quantified data of existing test requirements developed in the past, and determines a cluster to which the quantified data of the new test requirement belongs. The test case analysis section outputs, as test case candidates, existing test cases included in the determined cluster. At this time, a reusability evaluation section of the test case analysis section evaluates degrees of reusability of the existing test cases included in the test case candidates.

Such a test assistance device presents an existing test case having the highest degree of reusability from among the existing test cases manually generated in the past, in response to the new test requirement provided from outside, thereby streamlining test case generation.

### SUMMARY

A test assistance device according to a first aspect of the present disclosure is a test assistance device including a memory configured to store a program and a processor configured to execute the program. The processor, by executing the program, functions as a test case selection section configured to select, on the basis of a first attribute included in a test case group of system software, a target test case that is a test execution target from the test case group, a test mode determination section configured to determine, on the basis of a second attribute included in the selected target test case, whether the target test case is a test case for automatic testing, and a test case classification section configured to classify the target test cases determined by the test mode determination section into the target test case for automatic testing and the target test case for manual testing.

A test assistance method according to a second aspect of the present disclosure is a test assistance method executed by a test assistance device including a memory configured to store a program and a processor configured to execute the program. In the test assistance method, the processor, by executing the program, selects, on the basis of a first attribute included in a test case group of system software, a target test case that is a test execution target from the test case group, determines, on the basis of a second attribute included in the selected target test case, whether the target test case is a test case for automatic testing, and classifies the determined target test cases into the target test case for automatic testing and the target test case for manual testing.

A test assistance program according to a third aspect of the present disclosure is a test assistance program that causes a processor to execute a test case selection procedure of selecting, on the basis of a first attribute included in a test case group of system software, a target test case that is a test execution target from the test case group, a test mode determination procedure of determining, on the basis of a second attribute included in the selected target test case, whether the target test case is a test case for automatic testing, and a test case classification procedure of classifying the determined target test cases into the target test case for automatic testing and the target test case for manual testing.

A recording medium according to a fourth aspect of the present disclosure is a recording medium including the test assistance program according to the third aspect described above recorded on the recording medium in a computer-readable manner.

### BRIEF DESCRIPTION OF THE DRAWINGS

FIG. 1 is a schematic diagram illustrating a configuration of a test assistance system according to an embodiment.

FIG. 2 is a block diagram illustrating a configuration of a test assistance device according to an embodiment.

FIG. 3 is a diagram showing an example of a test case group according to an embodiment.

FIG. 4 is a block diagram illustrating functional sections of a control section according to an embodiment.

FIG. 5 is a flowchart illustrating test assistance processing according to an embodiment.

### DETAILED DESCRIPTION

In recent years, as a system development technique, a development technique of improving software while developing, testing, and releasing the software at short intervals while checking customer reaction has often been adopted.

In such a development technique, it is necessary to streamline a flow from preparation, including creating new test cases corresponding to software changes, selecting existing test cases requiring modification, selecting other existing test cases that should be executed, and the like, to test execution. In other words, the fact that the flow from test preparation to execution is not smooth is one factor that hinders a software release interval from becoming shorter.

Therefore, a configuration that can streamline the flow from test preparation to execution has been desired.

Hereinafter, an embodiment of the present disclosure will be described with reference to the drawings.

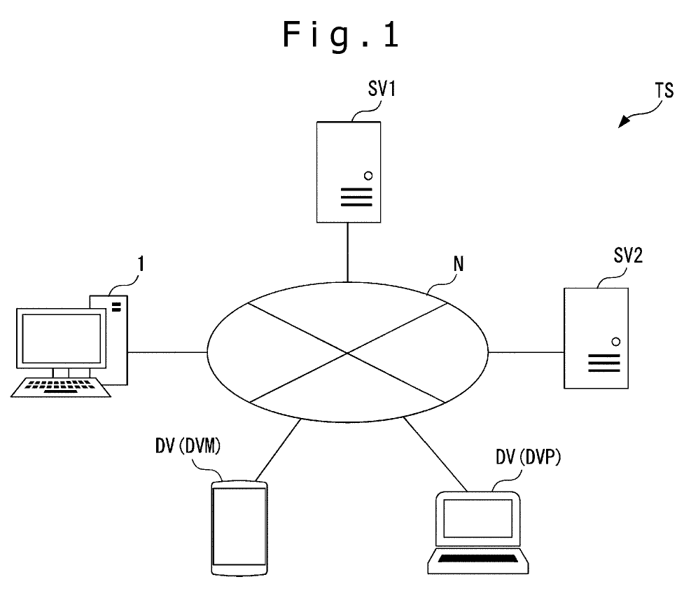

FIG. 1 is a schematic diagram illustrating a configuration of a test assistance system TS according to the present embodiment.

The test assistance system TS according to the present embodiment assists testing of system software. Specifically, the test assistance system TS classifies test cases defining test items of system software in accordance with test contents, test modes, and test execution devices, and performs execution of automatic testing and execution control of automatic testing by another device. The test assistance system TS, as illustrated in FIG. 1, includes a test assistance device 1, at least one external device DV, and a plurality of servers SV1 and SV2. The test assistance device 1, the external device(s) DV, and the plurality of servers SV1 and SV2 are configured to be communicable with each other through a network N. Note that the network N may be a network such as the Internet or a network in a company.

Hereinafter, each configuration of the test assistance system TS will be described.

The plurality of servers SV1 and SV2 are provided on the network N so as to be accessible from each of the test assistance device 1 and the external device(s) DV.

The server SV1 is, for example, a web server, and the system software to be tested by the test assistance device 1 and the external device(s) DV is installed therein.

The server SV2 is, for example, a file server and stores test cases to which test results are input by the test assistance device 1 and the external device(s) DV. That is, a predetermined region of a storage device included in the server SV2 is a save location for saving test results described below.

Note that the servers SV1 and SV2 need not be independent of each other, and the servers SV1 and SV2 may be configured by one server having a function of the server SV1 and a function of the server SV2.

A plurality of external devices DV are computers constituted by, for example, a personal computer (PC), a tablet, and a smartphone. In the example illustrated in FIG. 1, among the plurality of external devices DV, an external device DVP is a notebook PC, and an external device DVM is a mobile terminal such as a tablet or a smartphone. The external devices DV can communicate with the test assistance device 1 and the servers SV1 and SV2 through the network N.

A test assistance application is installed in advance in the external devices DV, and the external devices DV execute the test assistance application in accordance with control information input from the test assistance device 1, thereby executing automatic testing instructed by the test assistance device 1.

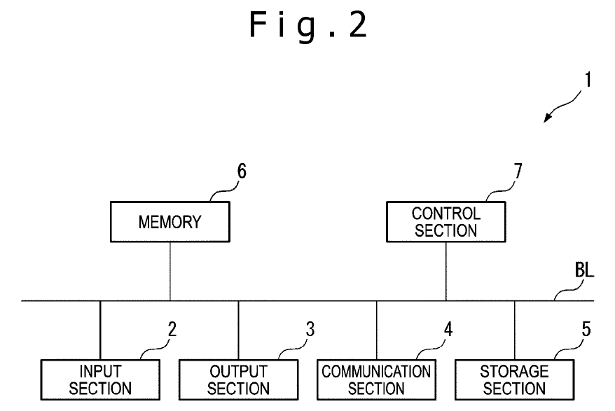

FIG. 2 is a block diagram illustrating a configuration of the test assistance device 1.

The test assistance device 1 is constituted by a PC that is an information processing device in the present embodiment, and performs classification of test cases of system software executed in the server SV1, execution of automatic testing of test cases that can be automatically tested among the classified test cases, and execution control of automatic testing by other devices.

As illustrated in FIG. 2, the test assistance device 1 includes an input section 2, an output section 3, a communication section 4, a storage section 5, a memory 6, and a control section 7. The input section 2, the output section 3, the communication section 4, the storage section 5, the memory 6, and the control section 7 are electrically connected to each other by a bus line BL.

The input section 2 receives an input operation by a user and outputs an operation signal corresponding to the input operation of the user to the control section 7. The input section 2 can be constituted by an input device such as a keyboard and a pointing device. The pointing device is, for example, a mouse or a touch panel.

The output section 3 outputs a processing result by the control section 7. Examples of the output section 3 include a display device that displays a screen during execution of a test assistance program described below.

The communication section 4, under the control of the control section 7, communicates with external equipment such as the external devices DV and the servers SV1 and SV2 through the network N.

The storage section 5 is a storage device that stores programs and data necessary for the operation of the test assistance device 1. For example, the storage section 5 stores a test assistance program that causes the control section 7 to execute test assistance processing. That is, the storage section 5 is a recording medium in which the test assistance program is recorded. In addition, the storage section 5 stores at least one test case acquired from the server SV2 or another test assistance device. The test case will be described in detail below.

The memory 6 is a work memory of the control section 7, and stores at least part of the program read out from the storage section 5.

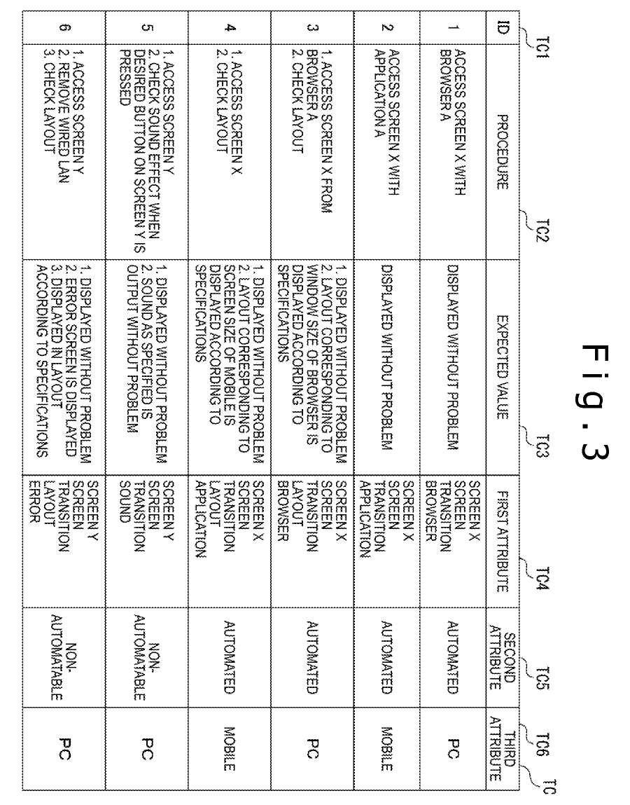

FIG. 3 is a diagram showing an example of a test case group TC.

The test case group TC shown as an example in FIG. 3 is an aggregate of a plurality of test cases in which test contents of system software installed in the server SV1 are described. The test case group TC includes a test ID field TC1, a procedure field TC2, an expected value field TC3, a first attribute field TC4, a second attribute field TC5, and a third attribute field TC6. That is, one test case includes a test ID, a procedure, an expected value, a first attribute, a second attribute, and a third attribute. The test case group TC may further include an input field into which a test result is input.

In the test ID field TC1, a number for identifying the test case is set.

In the procedure field TC2, a test procedure of the test case contents is set.

In the expected value field TC3, an expected value of the test case is set. The expected value is a correct test result when the test is implemented according to the procedure of the test case having the same test ID.

In the first attribute field TC4, the test categories of the test case having the same test ID are set. Specifically, in the first attribute field TC4, the test categories such as the screen to be tested, the test content, and the software used for testing are set.

For example, the test case with the test ID "1" is a test case for screen transition to screen X using a browser. Thus, in the first attribute field TC4 of the test case having the test ID "1", "Screen X" corresponding to the screen to be tested, "Screen transition" corresponding to the test content, and "Browser" corresponding to the software to be used are set as the test categories.

Further, for example, the test case with the test ID "5" is a test case for sound effects when a desired button is pressed on a screen Y. Thus, in the first attribute field TC4 of the test item having the test ID "5”, “Screen Y” corresponding to the screen to be tested, “Screen transition” corresponding to the test content, and “Sound” also corresponding to the test content are set as the test categories.

In the second attribute field TC5, whether the test case permits automatic testing is set. Specifically, “Automated” is set in the second attribute field TC5 in a case in which a test case having the same test ID permits automatic testing, and “Non-automatable” is set in the second attribute field TC5 in a case in which the test case does not permit automatic testing.

In the third attribute field TC6, an execution target of automatic testing based on a test case having the same test ID is set. In the present embodiment, in the third attribute field TC6, “PC” or “Mobile” is set as the execution target of automatic testing. Note that “Mobile” indicates a mobile terminal, but may be divided according to the operating system (OS) running on the mobile terminal, and may be further subdivided according to the OS version or model version. Further, in the third attribute field TC6, another execution target such as “Game device” may be set instead of or in addition to “PC” and “Mobile”.

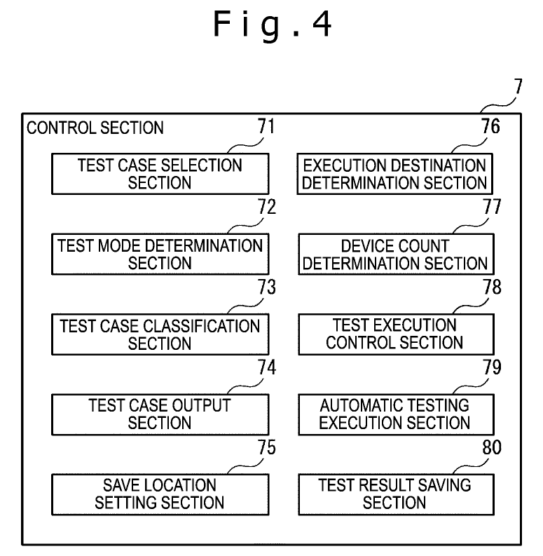

FIG. 4 is a block diagram illustrating functional sections of the control section 7.

The control section 7 includes at least one processor such as a central processing unit (CPU), and the processor executes a program such as an OS to control the test assistance device 1. Further, the control section 7 reads the test assistance program from the storage section 5 and executes the test assistance program, thereby executing test assistance processing.

Such a control section 7 includes a test case selection section 71, a test mode determination section 72, a test case classification section 73, a test case output section 74, a save location setting section 75, an execution destination determination section 76, a device count determination section 77, a test execution control section 78, an automatic testing execution section 79, and a test result saving section 80. These functional sections 71 to 80 are formed in the control section 7 by the processor executing the test assistance program.

The test case selection section 71 selects, on the basis of input test categories and first attributes included in test cases of the system software to be tested, target test cases that are test execution targets from among the test cases. Specifically, as the target test cases, the test case selection section 71 selects, from among the test cases of the system software to be tested, test cases in which the input test categories are included in the first attribute.

For example, in a case in which a test for screen transition is to be implemented, the test case selection section 71 selects, as the target test cases, the test cases in which “Screen transition” is included in the first attribute. In the example of the test case group TC shown in FIG. 3, in a case in which a screen transition test is to be implemented, the test case selection section 71 selects, as the target test cases, the test cases having the test IDs “1” to “6”.

Further, for example, in the example in FIG. 3, in a case in which a browser test is to be implemented, the test case selection section 71 selects, as the target test cases, the test cases having the test IDs “1” and “3”.

Note that the test category may be selected by the user. Alternatively, the test case selection section 71 may sequentially select, for system software testing, a test category from a plurality of test categories set in advance, and select the target test cases described above on the basis of the selected test category.

The test mode determination section 72 determines whether a target test case is a test case for automatic testing on the basis of the second attribute included in the target test case selected by the test case selection section 71. Specifically, the test mode determination section 72 acquires the second attribute of the target test case and determines whether the target test case is “Automated”.

The test case classification section 73 classifies the target test cases into target test cases determined to be test cases for automatic testing by the test mode determination section 72 and target test cases determined to be test cases for manual testing by the test mode determination section 72. That is, the test case classification section 73 distinguishably classifies the target test cases into target test cases having “Automated” as the second attribute and the target test cases having “Non-automatable” as the second attribute. At this time, the test case classification section 73 may create, from the original test cases, an automatic testing file in which the target test cases for automatic testing are copied, or may create a manual testing file in which the target test cases for manual testing are copied.

The test case output section 74, in a case in which a target test case for manual testing that is classified by the test case classification section 73 is present, outputs the target test case for manual testing to an output location set in advance. Note that examples of the output location include a predetermined region of a storage device included in the server SV2.

The save location setting section 75 sets a save location for test results based on the target test cases for automatic testing and test results based on the target test cases for manual testing. For example, as described above, the save location setting section 75 sets a predetermined folder included in the server SV2 or a predetermined file saved in the predetermined folder as the save location of the test results. Note that the save location setting section 75 may set at least the save location of the test results based on the target test cases for automatic testing, and need not necessarily set the save location of the test results based on the target test cases for manual testing.

The execution destination determination section 76 determines, on the basis of the third attribute included in a target test case for automatic testing, an execution destination device of automatic testing, the execution destination device being based on the target test case for automatic testing. For example, in a case in which the third attribute of the target test case for automatic testing is “PC”, the test assistance device 1, which is the target test case itself, or the external device DVP classified as a PC among the external devices DV can serve as the execution destination device of the target test case. For example, in a case in which the third attribute of the target test case for automatic testing is “Mobile”, the external device DVM classified as a mobile terminal among the external devices DV can serve as the execution destination device of the target test case.

Hereinafter, a test case in which the external device DVP classified as a PC is the execution destination device is referred to as a PC test case, and a test case in which the external device DVM classified as a mobile terminal is the execution destination device is referred to as a mobile terminal test case.

The device count determination section 77 determines the number of execution destination devices in accordance with the number of target test cases for automatic testing. Specifically, the device count determination section 77 determines the number of execution destination devices of PC test cases on the basis of, among the target test cases for automatic testing, the number of PC test cases with “PC” determined to be the execution destination device of automatic testing. The device count determination section 77 determines the number of execution destination devices of mobile terminal test cases on the basis of, among the target test cases for automatic testing, the number of mobile terminal test cases with “Mobile” determined to be the execution destination device of automatic testing.

For example, the device count determination section 77 determines the number of execution destination devices of PC test cases on the basis of a result of dividing the number of PC test cases by a predetermined first divisor.

Further, for example, the device count determination section 77 determines the number of execution destination devices of mobile terminal test cases on the basis of a result of dividing the number of mobile terminal test cases by a predetermined second divisor.

Note that the first divisor and the second divisor may differ from each other on the basis of a difference in arithmetic processing speed between the PC and the mobile terminal or the like, or may be the same value.

The test execution control section 78 causes, among the external devices DV that can communicate with the test assistance device 1 through the network N, the external device DVP, which is a PC, to execute automatic testing based on the PC test cases. At this time, the test execution control section 78 allocates the PC test cases to each of the external devices DVP of the number determined by the device count determination section 77, and causes the external device DVP to execute automatic testing based on the allocated PC test case. Note that, in a case in which the automatic testing execution section 79 of the test assistance device 1 executes automatic testing based on a PC test case, the test execution control section 78 also counts the test assistance device 1 as an execution destination device that executes automatic testing.

Similarly, the test execution control section 78 causes, among the external devices DV that can communicate with the test assistance device 1 through the network N, the external device DVM, which is a mobile terminal, to execute automatic testing based on the mobile terminal test case. At this time, the test execution control section 78 allocates the mobile terminal test case to each of the external devices DVM of the number determined by the device count determination section 77, and causes the external device DVM to execute automatic testing based on the allocated mobile terminal test case.

Note that, in a case in which there is a test case in which the execution of automatic testing in the external device DV fails, the test execution control section 78 causes re-execution of the automatic testing based on the test case. Such automatic testing is repeatedly executed a predetermined number of times until execution is completed. However, in a case in which the execution of automatic testing fails even after the predetermined number of times is reached, the result of the automatic testing based on the target test case is saved as an error.

On the other hand, the test execution control section 78 may cause the external device DV to re-execute the automatic testing. For example, in a case in which the cause of the error is eliminated or in a case in which a minor specification change is made, the test execution control section 78 causes the test assistance device 1 or the external device DV to execute automatic testing with the cause of the error eliminated or automatic testing based on a test case according to the minor specification change. At this time, the test execution control section 78 may cause, among the test assistance device 1 and the external devices DV, the device that executed the automatic testing in the past to re-execute the automatic testing.

In a case in which the test assistance device 1 is counted as an execution destination device of a PC test case, the automatic testing execution section 79 executes automatic testing based on the PC test case allocated by the test execution control section 78. In a case in which the number of PC test cases is small or in a case in which there is no available external device DVP, the automatic testing execution section 79 may execute automatic testing based on all PC test cases. If the automatic testing execution section 79 can execute automatic testing based on a mobile terminal test case, the automatic testing execution section 79 may execute automatic testing based on the mobile terminal test case allocated by the test execution control section 78.

Note that, in a case in which there is a target test case in which the execution of automatic testing by the automatic testing execution section 79 fails, the test execution control section 78 causes the automatic testing execution section 79 to repeatedly execute the automatic testing a predetermined number of times until the execution of automatic testing based on the target test case is completed, as in the case described above. In a case in which the execution of automatic testing fails even after the predetermined number of times is reached, the result of the automatic testing based on the target test case is saved as an error.

Further, as described above, the automatic testing execution section 79 may re-execute the automatic testing under the control of the test execution control section 78.

The test result saving section 80 saves the results of the automatic testing by the automatic testing execution section 79 in the save location set by the save location setting section 75. Specifically, the test result saving section 80 saves the result of the automatic testing based on the test case executed by the automatic testing execution section 79 for each test ID.

In a case in which the test execution control section 78 causes the external device DV to execute automatic testing, the test execution control section 78 acquires the result of the automatic testing from the external device DV that executed the automatic testing, and the test result saving section 80 saves the result of the automatic testing acquired by the test execution control section 78 in the save location. Note that, in a case in which the external device DV can access the save location described above, the external device DV may save the result of the automatic testing in the save location.

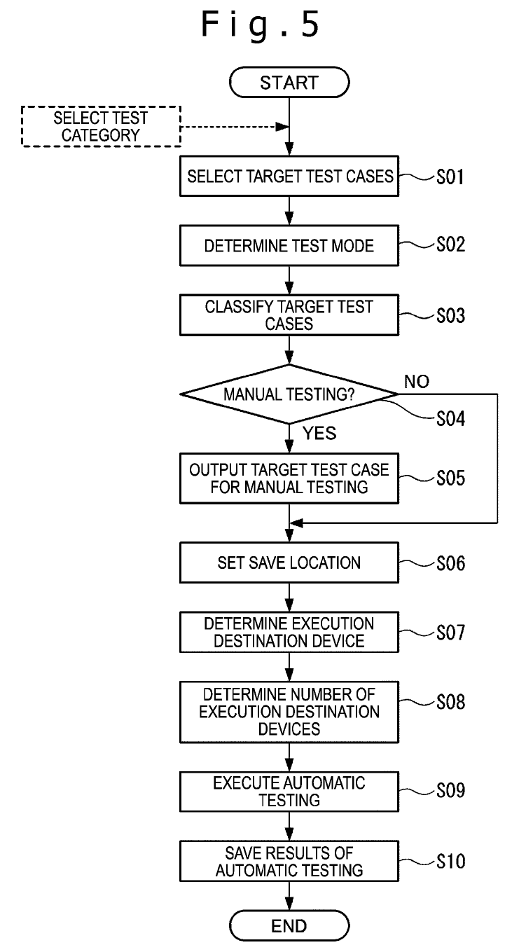

FIG. 5 is a flowchart illustrating test assistance processing.

The processor constituting the control section 7 of the test assistance device 1 executes the test assistance processing illustrated in FIG. 5. The test assistance processing is executed by the processor constituting the control section 7 reading out and processing the test assistance program stored in the storage section 5 and thus forming the functional sections 71 to 80 described above, and the functional sections 71 to 80 functioning accordingly.

Specifically, in the test assistance processing, first, the test case selection section 71 selects, among the test cases, target test cases that are test execution targets, on the basis of the selected test category and the first attribute of each test case (step S01).

Next, the test mode determination section 72 determines whether each target test case is automated or non-automatable on the basis of the second attributes of the selected target test cases (step S02).

Subsequently, the test case classification section 73 classifies the target test cases into target test cases for automatic testing and target test cases for manual testing, on the basis of the determination result by the test mode determination section 72 in step S02 (step S03).

Next, the test case output section 74 determines whether a target test case classified as a target test case for manual testing in step S03 is present (step S04). Note that, in a case in which a target test case for manual testing is not present, the control section 7 transitions the processing to step S06.

In a case in which a target test case classified as a target test case for manual testing in step S03 is present, the test case output section 74 outputs the target test case for manual testing to a predetermined output location (step S05). Subsequently, the control section 7 transitions the processing to step S06.

In step S06, the save location setting section 75 sets a save location of the test result (step S06).

Subsequently, the execution destination determination section 76 determines the execution destination device of each target test case for automatic testing on the basis of the third attribute included in each target test case for automatic testing (step S07).

Next, the device count determination section 77 determines the number of execution destination devices in accordance with the number of target test cases for automatic testing (step S08).

After step S08, the test execution control section 78 allocates the target test cases for automatic testing to, among the available external devices DV, the external devices DV of the number determined by the device count determination section 77, and causes the external devices DV to execute the automatic testing based on the allocated target test cases for automatic testing (step S09). In this step S09, in a case in which the test assistance device 1 is the execution destination device of automatic testing, the automatic testing execution section 79 executes the automatic testing based on the allocated target test case for automatic testing.

Then, the test result saving section 80 saves the result of the automatic testing by the automatic testing execution section 79 in the save location described above (step S10). At this time, in a case in which the test execution control section 78 acquires the results of the automatic testing by the external devices DV, the test result saving section 80 saves the results of the automatic testing by the external devices DV acquired by the test execution control section 78 in the save location described above.

Thus, the test assistance processing is completed.

The test assistance system TS according to the present embodiment described above has the following effects.

The test assistance system TS includes the test assistance device 1.

The test assistance device 1 includes the storage section 5 and the memory 6 that store the test assistance program, and the control section 7 that includes a processor that executes the test assistance program.

The processor constituting the control section 7 executes the test assistance program, and thus the processor functions as the test case selection section 71, the test mode determination section 72, and the test case classification section 73. That is, the test assistance device 1 includes the test case selection section 71, the test mode determination section 72, and the test case classification section 73.

The test case selection section 71 selects, on the basis of the first attributes included in the test case group of the system software, target test cases that are test execution targets from the test case group.

The test mode determination section 72 determines whether the target test cases are test cases for automatic testing on the basis of the second attribute included in the selected target test cases.

The test case classification section 73 classifies the target test cases determined by the test mode determination section 72 into target test cases for automatic testing and target test cases for manual testing. Note that the classified target test cases for manual testing are output by the test case output section 74.

According to such a configuration, the target test case that is a test execution target is selected from the test cases of the system software on the basis of the first attribute. For example, in a case in which a test related to a certain test category is to be implemented, when the user selects or inputs the test category by using the test assistance device 1, the test case selection section 71 selects target test cases related to the test category on the basis of the first attribute. Then, the target test cases are classified into target test cases for automatic testing and target test cases for manual testing on the basis of the second attribute. According to this configuration, it is not necessary to manually divide the target test cases into the target test cases for automatic testing and the target test cases for manual testing. Accordingly, it is possible to streamline the flow from test case generation to test execution and thus shorten a software release interval.

In the test assistance device 1, the processor constituting the control section 7 functions as the automatic testing execution section 79 that executes automatic testing based on target test cases for automatic testing. That is, the test assistance device 1 includes the automatic testing execution section 79.

According to such a configuration, automatic testing based on the target test case for automatic testing classified by the test case classification section 73 can be automatically executed by the automatic testing execution section 79. Accordingly, it is possible to shorten a test period and shorten the software release interval.

In the test assistance device 1, the automatic testing execution section 79 re-implements the automatic testing based on the target test case in which the execution has failed.

According to such a configuration, in a case in which network failure temporarily occurs and automatic testing through the network cannot be executed, for example, the automatic testing execution section 79 re-executes the automatic testing, making it possible to perform the automatic testing again after the network failure is resolved. Accordingly, it is possible to appropriately determine pass/fail results of the test case.

In the test assistance device 1, the processor constituting the control section 7 functions as the save location setting section 75 and the test result saving section 80. That is, the test assistance device 1 includes the save location setting section 75 and the test result saving section 80.

The save location setting section 75 sets the save location for test results based on the target test cases for automatic testing and test results based on the target test cases for manual testing.

The test result saving section 80 stores the test results of the automatic testing by the automatic testing execution section 79 in the save location described above. Note that the test result saving section 80 may also save the results of the automatic testing by the external devices DV in the save location described above.

According to such a configuration, the test results of automatic testing and the test results of manual testing are saved in the set save location, making it possible to easily manage each test result. At this time, the test result saving section 80 saves the test results of automatic testing in the set save location, allowing the user to save time and effort in saving the test results of automatic testing in the save location. Accordingly, it is possible to streamline a flow from test implementation to test result verification and shorten the software release interval.

In the test assistance device 1, the processor constituting the control section 7 functions as the execution destination determination section 76 and the test execution control section 78. That is, the test assistance device 1 includes the execution destination determination section 76 and the test execution control section 78.

The execution destination determination section 76 determines, on the basis of the third attribute included in a target test case for automatic testing, an execution destination device of automatic testing, the execution destination device being based on the target test case for automatic testing.

The test execution control section 78 causes the execution destination device determined by the execution destination determination section 76 to execute the automatic testing.

According to such a configuration, it is possible to cause a device corresponding to the content of automatic testing based on the test case to implement the automatic testing. Accordingly, it is possible to appropriately determine the pass/fail results of the test case.

In the test assistance device 1, the processor constituting the control section 7 functions as the device count determination section 77. That is, the test assistance device 1 includes the device count determination section 77.

The device count determination section 77 determines the number of external devices DV, which are execution destination devices for executing automatic testing, according to the number of target test cases for automatic testing.

The test execution control section 78 causes the determined number of external devices DV to execute automatic testing.

According to such a configuration, it is possible to implement automatic testing by a plurality of external devices DV, for example, and thus shorten the implementation period of automatic testing. Accordingly, it is possible to shorten the software release interval.

The test assistance processing corresponds to a test assistance method executed by the test assistance device 1. As described above, the test assistance device 1 includes the storage section 5 and the memory 6 that store the test assistance program, and the control section 7 that includes the processor that executes the test assistance program. In the test assistance processing, the processor constituting the control section 7 executes the test assistance program, and thus the processor executes the test case selection procedure, the test mode determination procedure, and the test case classification procedure.

In the test case selection procedure, the processor selects target test cases that are test execution targets, from the test case group on the basis of the first attributes included in the test case group of the system software.

In the test mode determination procedure, the processor determines whether the target test cases are test cases for automatic testing based on the second attributes included in the selected target test cases.

In the test case classification procedure, the processor classifies the determined target test cases into target test cases for automatic testing and target test cases for manual testing.

According to such test assistance processing, it is possible to achieve effects similar to those of the test assistance device 1 described above.

The test assistance program causes the processor constituting the control section 7 to execute the test case selection procedure, the test mode determination procedure, and the test case classification procedure described above.

By the processor executing such a test assistance program, effects similar to those of the test assistance device 1 described above can be achieved.

The storage section 5 is a recording medium in which the test assistance program is recorded in a computer-readable manner.

The processor constituting the computer reads the test assistance program from the storage section 5 and executes the test assistance program, making it possible to achieve effects similar to those of the test assistance device 1 described above.

In the present embodiment, the test assistance program is recorded in the storage section 5 formed by a storage device, but may be recorded in another recording medium such as a disk-type recording medium.

The present disclosure is not limited to the above-described embodiment, and modifications, improvements, and the like within a range in which the object of the present disclosure can be achieved are included in the present disclosure.

In the embodiment described above, the test assistance device 1 includes the automatic testing execution section 79 that executes automatic testing on the basis of the target test case for automatic testing. However, the test assistance device 1 is not limited thereto, and need not include the automatic testing execution section 79. In this case, the test execution control section 78 may cause the external device DV to execute automatic testing based on the target test case for automatic testing. Alternatively, in a case in which the test case output section 74 outputs the classified target test case for automatic testing to the output location described above, the external device DV may read the output target test case for automatic testing and execute automatic testing based on the read target test case for automatic testing.

In the embodiment described above, the automatic testing execution section 79 re-executes automatic testing based on the target test case for automatic testing in which the execution has failed. Further, the test execution control section 78 re-executes the automatic testing based on the target test case for automatic testing in which the execution has failed in the external device DV. However, execution is not limited thereto, and the automatic testing execution section 79 need not re-execute automatic testing based on the target test case in which the execution has failed, and the test execution control section 78 need not cause the external device DV to re-execute automatic testing based on the target test case in which the execution has failed.

In the embodiment described above, the save location setting section 75 sets the save location for storing the test results of automatic testing. However, the configuration is not limited thereto, and the save location setting section 75 need not set the save location in a case in which the save location is set in advance or the like. That is, the test assistance device 1 need not include the save location setting section 75.

Further, the save location is set in the server SV2 with which the test assistance device 1 can communicate through the network N. However, the save location is not limited thereto, and may be set in the storage section 5 included in the test assistance device 1, and can be changed as appropriate.

In the embodiment described above, the execution destination determination section 76 determines, on the basis of the third attribute included in the target test case for automatic testing, the execution destination device of the target test case, and the test execution control section 78 causes the determined execution destination device to execute automatic testing based on the target test case. However, the configuration is not limited thereto, and the execution destination determination section 76 need not determine the execution destination device in a case in which testing by the plurality of devices need not be implemented such as when the devices that can access the system to be tested are limited, for example. That is, the test assistance device 1 need not include the execution destination determination section 76.

In the embodiment described above, the device count determination section 77 determines, in accordance with the number of selected target test cases, the number of external devices DV that are to execute automatic testing based on target test cases. Then, the test execution control section 78 allocates the target test cases corresponding to the execution destination devices to the determined number of external devices DV, and causes the external devices DV to execute automatic testing based on the allocated target test cases. However, the configuration is not limited thereto, and the test execution control section 78 may cause all available external devices DV provided communicably with the test assistance device 1 to execute automatic testing based on the allocated target test cases. Further, the test execution control section 78 may cause the external devices DV determined in advance to execute automatic testing based on the target test cases.

In the embodiment described above, the test case group TC shown in FIG. 3 is exemplified as a test case group of system software. However, the configuration is not limited thereto, and the content of the test case group is not limited to the above. For example, the test case group is not limited to content related to test items pertaining to the layout of each screen, screen transitions, used software, and sound, and may be related to other content.

In the embodiment described above, the processor constituting the control section 7 reads and executes the test assistance program recorded in the storage section 5. However, the configuration is not limited thereto, and the processor may be configured to read and execute the test assistance program from the recording medium during execution of the test assistance processing, for example. Such a recording medium is exemplified by a magnetic tape, a disk-type recording medium, and a semiconductor memory. Furthermore, the processor may acquire the test assistance program from a device on the network N and then execute the test assistance program.

A summary of the present disclosure is provided below.

[1] A test assistance device including:

a memory configured to store a program; and

a processor configured to execute the program,

wherein the processor, by executing the program, functions as

a test case selection section configured to select, on the basis of a first attribute included in a test case group of system software, a target test case that is a test execution target from the test case group,

a test mode determination section configured to determine, on the basis of a second attribute included in the selected target test case, whether the target test case is a test case for automatic testing, and

a test case classification section configured to classify the target test cases determined by the test mode determination section into the target test case for automatic testing and the target test case for manual testing.

According to such a configuration, the target test case that is a test execution target is selected from the test cases of the system software on the basis of the first attribute. Then, the target test cases are classified into target test cases for automatic testing and target test cases for manual testing on the basis of the second attribute. According to this configuration, it is not necessary to manually divide the target test cases into the target test cases for automatic testing and the target test cases for manual testing. Accordingly, it is possible to streamline the flow from test case generation to test execution and thus shorten a software release interval.

[2] The test assistance device according to [1],

wherein the processor functions as an automatic testing execution section configured to execute automatic testing based on the target test case for automatic testing.

According to such a configuration, the automatic testing based on the target test case for automatic testing that is classified by the test case classification section can be automatically executed by the automatic testing execution section. Accordingly, it is possible to shorten a test period and shorten the software release interval.

[3] The test assistance device according to [2],

wherein the automatic testing execution section re-executes automatic testing based on the target test case in which the execution fails.

According to such a configuration, in a case in which network failure temporarily occurs and automatic testing through the network cannot be executed, for example, the automatic testing execution section re-executes the automatic testing, making it possible to perform the automatic testing again after the network failure is resolved. Accordingly, it is possible to appropriately determine pass/fail results of the test case.

[4] The test assistance device according to [2] or [3],

wherein the processor functions as

a save location setting section configured to set a save location of a test result based on the target test case for automatic testing and a test result based on the target test case for manual testing, and

a test result saving section configured to save a test result of automatic testing by the automatic testing execution section in the save location.

According to such a configuration, the test results of automatic testing and the test results of manual testing are saved in the set save location, making it possible to easily manage each test result. At this time, the test result saving section saves the test results of automatic testing in the set save location, allowing the user to save time and effort in saving the test results of automatic testing in the save location. Accordingly, it is possible to streamline a flow from test implementation to test result verification and shorten the software release interval.

[5] The test assistance device according to any one of [1] to [4],

wherein the processor functions as

an execution destination determination section configured to determine, on the basis of a third attribute included in the target test case for automatic testing, an execution destination device of automatic testing based on the target test case for automatic testing, and

a test execution control section configured to cause the determined execution destination device to execute automatic testing.

According to such a configuration, it is possible to cause a device corresponding to the content of automatic testing based on the test case to implement the automatic testing. Accordingly, it is possible to appropriately determine the pass/fail results of the test case.

[6] The test assistance device according to [5],

wherein the processor functions as a device count determination section configured to determine the number of the execution destination devices in accordance with the number of the target test cases for automatic testing, and

the test execution control section causes the execution destination devices of the determined number to execute the automatic testing.

According to such a configuration, it is possible to implement automatic testing by a plurality of execution destination devices, for example, and thus shorten an implementation period of automatic testing. Accordingly, it is possible to shorten the software release interval.

[7] A test assistance method executed by a test assistance device including a memory configured to store a program and a processor configured to execute the program, wherein the processor, by executing the program,

selects, on the basis of a first attribute included in a test case group of system software, a target test case that is a test execution target from the test case group,

determines, on the basis of a second attribute included in the selected target test case, whether the target test case is a test case for automatic testing, and

classifies the determined target test cases into the target test case for automatic testing and the target test case for manual testing.

According to such a test assistance method, it is possible to achieve effects similar to those of the test assistance device described above.

[8] A test assistance program that causes a processor to execute:

a test case selection procedure of selecting, on the basis of a first attribute included in a test case group of system software, a target test case that is a test execution target from the test case group,

a test mode determination procedure of determining, on the basis of a second attribute included in the selected target test case, whether the target test case is a test case for automatic testing, and

a test case classification procedure of classifying the determined target test cases into the target test case for automatic testing and the target test case for manual testing.

With the processor executing such a test assistance program, effects similar to those of the test assistance device described above can be achieved.

[9] A recording medium including the test assistance program according to [8] recorded on the recording medium in a computer-readable manner.

With a computer reading and executing the test assistance program from such a recording medium, effects similar to those of the test assistance device described above can be achieved.

What is claimed is:

1. A test assistance device comprising:
a memory configured to store instructions; and
a processor configured to execute the instructions that, when executed by the processor, cause the processor to:
select, based on a first attribute included in a test case group of system software, a target test case that is a test execution target from the test case group;
determine, based on a second attribute included in the target test case, whether the target test case is a test case for automatic test; and
classify the target test cases into the target test case for automatic test and the target test case for manual test.

2. The test assistance device according to claim 1, wherein the execution of the instructions further cause the processor to execute an automatic test based on the target test case for automatic test.

3. The test assistance device according to claim 2, wherein the execution of the instructions further cause the processor to:
set a save location of a test result based on the target test case for automatic test and a test result based on the target test case for manual test; and
save a test result of automatic test in the save location.

4. The test assistance device according to claim 2, wherein the execution of the instructions further cause the processor to re-execute the automatic test when execution of the automatic test fails.

5. The test assistance device according to claim 4, wherein the processor is configured to repeatedly re-execute the automatic test for a target test case in which execution fails, up to a predetermined number of times, and to save the result as an error if execution fails after the predetermined number of times.

6. The test assistance device according to claim 1, wherein the execution of the instructions further cause the processor to:
determine, based on a third attribute included in the target test case for automatic test, an execution destination device of automatic test; and
cause the execution destination device to execute the automatic test.

7. The test assistance device according to claim 6, wherein the execution of the instructions further cause the processor to:
determine a number of execution destination devices in accordance with a number of the target test cases for automatic test; and
cause the execution destination devices of the determined number to execute the automatic test.

8. The test assistance device according to claim 6, wherein the execution destination device is selected from a plurality of device types including at least a personal computer and a mobile terminal, and the processor allocates automatic test cases to execution destination devices based on the third attribute specifying the device type.

9. A method comprising:
selecting, based on a first attribute included in a test case group of system software, a target test case that is a test execution target from the test case group;
determining, based on a second attribute included in the target test case, whether the target test case is a test case for automatic test; and
classifying the determined target test cases into the target test case for automatic test and the target test case for manual test.

10. The method according to claim 9, further comprising executing an automatic test is based on the target test case for automatic test.

11. The method according to claim 10, further comprising re-executing the automatic test when execution of the automatic test fails.

12. The method according to claim 10, further comprising:
setting a save location of a test result based on the target test case for automatic test and a test result based on the target test case for manual test; and
saving a test result of automatic test in the save location.

13. The method according to claim 9, further comprising:
determining, based on a third attribute included in the target test case for automatic test, an execution destination device of automatic test; and
causing the execution destination device to execute the automatic test.

14. The method according to claim 13, further comprising:
determining a number of execution destination devices in accordance with a number of the target test cases for automatic test; and
causing the execution destination devices of the determined number to execute the automatic test.

15. A non-transitory computer-readable medium storing computer-readable instructions that, when executed by a processor, cause the processor to perform operations comprising:
selecting, based on a first attribute included in a test case group of system software, a target test case that is a test execution target from the test case group,
determining, based on a second attribute included in the target test case, whether the target test case is a test case for automatic test, and
classifying the determined target test cases into the target test case for automatic test and the target test case for manual test.

16. The non-transitory computer-readable medium according to claim 15, wherein the operations further comprise executing an automatic test is based on the target test case for automatic test.

17. The non-transitory computer-readable medium according to claim 16, wherein the operations further comprise re-executing the automatic test when execution of the automatic test fails.

18. The non-transitory computer-readable medium according to claim 16, wherein the operations further comprise:
setting a save location of a test result based on the target test case for automatic test and a test result based on the target test case for manual test; and
saving a test result of automatic test in the save location.

19. The non-transitory computer-readable medium according to claim 15, wherein the operations further comprise:
determining, based on a third attribute included in the target test case for automatic test, an execution destination device of automatic test; and
causing the execution destination device to execute the automatic test.

20. The non-transitory computer-readable medium according to claim 19, wherein the operations further comprise:
determining a number of execution destination devices in accordance with a number of the target test cases for automatic test; and
causing the execution destination devices of the determined number to execute the automatic test.
